(19) United States
(12) Patent Application Publication
(10) Pub. No.: US 2006/0252433 A1
(43) Pub. Date: Nov. 9, 2006

(54) Method for a supervisor to monitor the proximity of multiple charges - typically children

(76) Inventor: Jesse Benedict Rothschild, St. Francisville, LA (US)

Correspondence Address: Jesse Benedict Rothschild, 10441 Jacock Rd., St. Francisville, LA, 70775, US

(21) Appl. No.: 11/123,684

(22) Filed: May 6, 2005

(51) Int. Cl. H04Q 7/20

(52) U.S. Cl. 455/456.5; 455/456.1

(57) ABSTRACT

A method for a supervisor to monitor the proximity of multiple charges—typically children, with the steps of: the use of portable radio frequency transmitters, the use of a common portable radio frequency receiver, the use of audible alarm(s), and/or light(s) or light-emitting-diode(s), and/or vibrating mechanism(s), the use of a method of identification for each transmitter's radio frequency signal, the use of a method of notification in the event of a loss of reception of any transmitter's radio frequency signal, the use of cases or enclosures for containing and carrying or wearing the transmitter(s) and receiver(s), i.e. wrist bands, clip-on cases, cases with carrying straps, and the use of portable power sources, such as batteries and/or solar cells for energizing the transmitter(s), receiver(s), and alerting device(s).

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of personal safety and more specifically to a method for a supervisor to monitor the proximity of multiple charges, typically children, utilizing multiple portable radio frequency transmitters monitored by a common portable radio frequency receiver.

Devices have been available for a number of years now that alert a person when they are separated from an object, possession, or charge (typically a child). These devices have been either: 1. Stationary monitoring stations to monitor multiple charges, or 2. portable monitoring devices for the monitoring of the proximity of only one transmitter placed on, in, or with objects, possessions, or charges.

Prior methods of maintaining proximity between a supervisor and his or her charge have included: physical methods of attachment, such as a leash or tether; the use of one portable radio frequency transmitter matched to one portable radio frequency receiver; the use of a stationary monitoring device to monitor multiple charges; or more elaborate and costly devices utilizing Global Positioning Satellite technology.

The deficiency of prior portable radio frequency transmission and reception methods is in the one-to-one relationship. Utilizing prior portable radio frequency transmission and reception methods, the supervisor would be required to wear or carry multiple receivers to monitor multiple transmitters due to the one-to-one relationship.

### BRIEF SUMMARY OF THE INVENTION

The primary object of the invention is to provide a portable method of monitoring, and therefore maintaining, the proximity to multiple charges, typically children, for the purpose of supervision, without the use of physical devices of attachment.

Another object of the invention is to provide a method of notification when the distance between the supervisor and one or more of his or her charges exceeds a specified or pre-selected distance.

Another object of the invention is to provide a method of identifying which charge has become separated from his or her supervisor by more than the specified or pre-selected distance.

Other objects and advantages of the present invention will become apparent from the following descriptions, wherein, an embodiment of the present invention is disclosed.

In accordance with a preferred embodiment of the invention, there is disclosed a method for a supervisor to monitor the proximity of multiple charges—typically children, comprising the steps of: the use of portable radio frequency transmitters energized by portable power sources, i.e. a battery and/or solar cell, the use of a common portable radio frequency receiver energized by a portable power source, i.e. a battery and/or solar cell, the use of audible alarm(s), and/or light(s) or light-emitting-diode(s), and/or vibrating mechanism(s) that can be energized for the purpose of alerting the carrier or wearer of the portable receiver and/or transmitter, the use of a method of identification for each transmitter's radio frequency signal, the use of a method of notification in the event of the receiver's loss of reception of any transmitter's radio frequency signal, the use of cases or enclosures for containing and carrying or wearing the transmitter(s) and receiver(s), i.e. wrist bands, clip-on cases, cases with carrying straps, and the use of portable power sources, such as batteries and/or solar cells for energizing the transmitter(s), receiver(s), and alerting device(s).

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

In accordance with the present invention, a supervisor or supervisors who desire to portably monitor and maintain a controlled proximity to their charges—typically children—will wear or carry a receiver that receives radio frequency signals from multiple transmitters, and can identify each individual transmitter. The receiving device communicates by electronic circuitry to an alert mechanism, such as an alarm, digital display, light, and/or vibrating mechanism.

In further accordance with the present invention, each individual charge will wear or carry a portable transmitter that sends a continuous radio frequency transmission, of predetermined or variable signal power or strength, to the receiver worn or carried by the supervisor.

In further accordance with the invention, when a transmitter or transmitters is/are separated in distance from the receiver by more than the pre-selected or chosen distance, the receiver no longer can receive the radio frequency transmission sent by the transmitter or transmitters. As a consequence, the receiver activates the alert mechanism, and provides and communicates an identifier for which transmitter's or transmitters' signals is/are no longer being received.

In the preferred embodiment of the invention, the method described above comprises: portable radio frequency transmitters energized by portable power sources, i.e. a battery and/or solar cell; a common portable radio frequency receiver energized by a portable power source, i.e. a battery and/or solar cell; audible alarm(s), and/or light(s) or light-emitting-diode(s), and/or vibrating mechanism(s) that can be energized for the purpose of alerting the carrier or wearer of the receiver and/or transmitter; a method of identification for each transmitter's radio frequency signal; a method of notification in the event of a loss of reception of any transmitter's radio frequency signal; a method of conveying the identity of the transmitter or transmitters who's transmissions are no longer being received; and portable power sources, such as batteries and/or solar cells for energizing the transmitter(s), receiver(s), alerting device(s), and notification device(s). The devices utilized in the method will be encased or enclosed for the purpose of conveniently carrying or wearing the devices, and will include attachment devices. Exemplary encasements, enclosures, and attachment devices include wrist bands, watch-style cases, clip-on cases, cases with carrying straps, and/or necklaces. The exemplary encasements or enclosures may be weather or water resistant or proof.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A method for a supervisor to monitor the proximity of multiple charges—typically children, comprising:
the use of portable radio frequency transmitters energized by portable power sources, i.e. a battery and/or solar cell;
the use of a common portable radio frequency receiver energized by a portable power source, i.e. a battery and/or solar cell;
the use of audible alarm(s), and/or light(s) or light-emitting-diode(s), and/or vibrating mechanism(s) that can be energized for the purpose of alerting the carrier or wearer of the receiver and/or transmitter;
the use of a method of identification for each transmitter's radio frequency signal;
the use of a method of notification in the event of a loss of reception of any transmitter's radio frequency signal;
the use of cases or enclosures for containing and carrying or wearing the transmitter(s) and receiver(s), i.e. wrist bands, clip-on cases, cases with carrying straps; and
the use of portable power sources, such as batteries and/or solar cells for energizing the transmitter(s), receiver(s), and alerting device(s).
